(19) United States
(12) Patent Application Publication
(10) Pub. No.: US 2025/0198829 A1
(43) Pub. Date: Jun. 19, 2025

(54) MONOLITHIC FLEXIBLE JOINT ASSEMBLY, AND BOTTOM-LOADING BALANCE

(71) Applicant: SARTORIUS LAB INSTRUMENTS GMBH & CO. KG, Goettingen (DE)

(72) Inventors: Falko HILBRUNNER, Ilmenau (DE); Thomas FROEHLICH, Ilmenau (DE); Mario SCHREIBER, Goesen (DE); Tim SCHULZ, Untermassfeld (DE); Thomas FEHLING, Witzenhausen (DE)

(21) Appl. No.: 19/043,823

(22) Filed: Feb. 3, 2025

Related U.S. Application Data
(63) Continuation of application No. PCT/EP2023/070286, filed on Jul. 21, 2023.

(30) Foreign Application Priority Data
Aug. 2, 2022 (DE) 10 2022 119 372.1

(51) Int. Cl. G01G 21/07

(52) U.S. Cl. CPC G01G 21/07

(57) ABSTRACT

A monolithic flexure joint arrangement includes a main body (12) through which a first channel pair (24-1) and a second channel pair (24-2) pass. The channel pairs are aligned mutually perpendicular in a radial plane and both intersect with a central axis normal to the radial plane in the center of the main body. Each channel pair has two individual through channels aligned mutually parallel, which are arranged with convexly curved channel wall portions facing one another and adjoining one another such that webs extending between the curved channel wall portions commonly form a flexure joint (22). A central piece (16) of the main body is pivotably articulated to an input piece (18) with a first flexure joint (22-1) formed between the through-channels of the first channel pair as well as to an output piece (20) with a second flexure joint (22-2) formed between the through-channels of the second channel pair.

### CROSS-REFERENCE TO RELATED APPLICATION

This is a Continuation of International Application PCT/EP2023/070286, which has an international filing date of Jul. 21, 2023, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 10 2022 119 372.1 filed on Aug. 2, 2022.

### FIELD

The invention relates to a monolithic flexure joint arrangement comprising a main body through which two pairs of channels, namely a first pair of channels and a second pair of channels, pass and which pairs of channels are aligned perpendicular to each other in a radial plane and intersect each other and a central axis normal to the radial plane in the center of the main body, wherein each pair of channels has two individual through channels aligned parallel to one another, which are arranged with convexly curved channel wall portions facing one another and closely adjacent to one another such that webs extending between the curved channel wall portions commonly form a flexure joint, wherein a central piece of the main body is pivotably articulated to an input piece, which is otherwise unconnected thereto, by a first flexure joint formed between the through-channels of the first pair of channels and is pivotably articulated to an output piece, which is otherwise unconnected thereto, by a second flexure joint formed between the through-channels of the second pair of channels.

### BACKGROUND

The invention also relates to a lower-pan balance whose load carrier is coupled to the load receptor of its weighing system via such a flexure joint arrangement.

A conventional flexure joint arrangement is known from DE 21 14 802 A.

Precision balances, which are used in particular as so-called comparators for calibrating or verifying test weights against standardized or calibration weights, are often designed as balances with a lower weighing pan. In the case of balances with a lower pan, the load carrier intended to hold the sample is arranged below the load receptor and coupled to it via a coupling joint. The load receptor, for its part, is part of a so-called weighing system, i.e. a more or less complex construction consisting of levers and links, which transmits a weight force acting on the load receptor to the actual sensor with a suitable path or force translation. In the case of balances that operate according to the principle of electromagnetic compensation (EMF balances), for example, these can be designed as a plunger coil arrangement, wherein the coil current required to maintain the state of equilibrium serves as a measured variable that is representative of the weight force acting on the load receptor. However, the specific mode of operation of the sensor does not play a role in the present invention. In any case, it is desirable that the weight force exerted by the mass to be weighed on the load carrier is introduced exactly vertically into the load receptor of the weighing system. This requires an articulated coupling between the load receptor and the load carrier, which enables pivot movements around two horizontal pivot axes that are perpendicular to each other. These pivot axes should preferably run in the same horizontal plane.

A monolithic flexure joint arrangement suitable for this purpose is known from the publication mentioned above, wherein the preferred application mentioned in the publication is the coupling of a drive shaft with a flywheel. The main body of the known flexure joint arrangement has the hollow cylindrical basic shape of a tube section. This is subdivided into three axial sections, the middle of which can be designated as the central piece and the axially outer ones as the input and output pieces, wherein this designation serves solely to structurally differentiate the elements without any functional implication. The input and output pieces are each pivotably linked to the central piece via a flexure joint, wherein the two pivot axes lie in the same radial plane of the main body, in particular in its central plane, and run perpendicular to each other. Each of the two flexure joints is made up of two material thinning points, which lie radially opposite each other in pairs in the tube wall of the hollow cylindrical main body. Each material thin section is formed by the web between two adjoining, i.e., closely adjacent, bores through the tube wall. The two individual bores, each lying on a parallel to the radial, can together be regarded as a through channel through the hollow cylindrical main body interrupted by the lumen of the tube section. Each flexure joint is therefore formed by a pair of channels consisting of two adjoining through channels through the main body. Each bore is connected to its partner lying on the same radial parallel via a through-slot running halfway around the main body, whereby a complete separation of the central piece on the one hand from the input and output piece on the other is realized with the exception of the flexure joint connections.

In two aspects, the known flexure joint arrangement is disadvantageous with regard to its use as an articulated coupling between the load carrier and the load receptor of a lower-pan balance. Firstly, it is difficult to fix the essentially ring-shaped input and output pieces straight to the load receptor or load carrier. This is particularly true in view of the fact that the coupling of precision instruments should ideally be adjustable both vertically and azimuthally. On the other hand, it must be considered a disadvantage that each of the two flexure joints consists of only two quasi point-shaped material thin sections. Such joints are not completely rigid against parasitic movement components and are particularly susceptible to torsional movements. Accordingly, the aforementioned publication also stipulates that the flexure joint arrangement described should not be used alone, but only in combination with a similarly constructed flexure joint arrangement, wherein both arrangements are inserted concentrically into one another. This entails additional assembly work and a loss of precision, which is probably still acceptable in the context of a drive shaft, but is unacceptable for the articulation of the load carrier to the load receptor of a precision balance, which is the focus here.

### SUMMARY

It is an object of the present invention to further develop a generic flexure joint arrangement such that it is more suitable for coupling the load carrier to the load receptor of a lower-pan precision balance.

This and other objects are addressed with the features recited in the independent claims. According to one formulation, the input piece and/or the output piece is configured as a beam passing radially through the central piece.

A lower-pan balance with corresponding coupling of its load carrier to its load receptor is also claimed.

Further exemplary embodiments of the invention are the subject of the dependent claims.

The invention departs from the essentially hollow cylindrical basic shape of the main body of the flexure joint arrangement known from the prior art and provides for an essentially filled cylindrical basic shape of the main body. The pair of channels forming the respective flexure joint is no longer limited to corresponding bores through a thin tube wall, but consists of real channels which are surrounded by channel walls over their entire length or at least a substantial part thereof. As a result, the web that exists between the individual channels of the channel pair and defines the pivot axis of the respective flexure joint is also extended and extends essentially radially through the entire main body. Only in the central area, i.e. in the intersection area of the two channel pairs, does the intersection of the channel lumens automatically create a comparatively small cavity that interrupts the channels. In the disclosed embodiment, in which the input and output elements are configured as radial beams, each flexure joint is therefore composed of two webs each extending over almost half the diameter of the main body, which leads to a much more precise definition of the pivot axes than was the case when they were defined by just two quasi-point-shaped material thins in the prior art.

A further advantage of the disclosed embodiment according to the invention is that the central points of the end faces of the input or output piece are not located in the hollow lumen of the tubular main body, but in the material of the input or output piece. This makes it possible to attach coupling elements to the load receptor or load carrier at a central point directly on the inlet or outlet piece. Representative embodiments of such coupling elements will be described in more detail below.

Finally, a third advantage of the embodiment according to the invention is that the inlet or outlet piece can be configured to be nested with the central piece. If the inlet and/or outlet piece is configured as a beam passing radially through the central piece, the central piece itself can fill the remaining space to the side of this beam at the same axial height. In the prior art, this was not the case; there, the inlet and/or outlet piece on the one hand and the central piece on the other had to be arranged purely axially adjacent to each other. The configuration according to the invention therefore allows a significant axial saving in installation space.

In the disclosed embodiment, as mentioned, not only the inlet or outlet piece, but both the inlet and outlet piece are each configured as a beam that radially passes through the central piece, wherein the beams are offset against and aligned perpendicular to each other and perpendicular to the central axis. As a result, the inlet and outlet pieces remain in different axial sections of the main body; however, their associated pivot axes lie in the same radial plane. As explained at the beginning, this is advantageous for applications in precision weighing technology.

Preferably, the input piece has a fixation opening coaxial to the central axis on its side facing away from the associated flexure joint for receiving a coupling pin. As explained above, there is “flesh” of the input piece in the central area of the flexure joint arrangement. An opening can be made here that serves as an interface for a coupling pin, with which the input piece can be fixed to the load receptor (preferably) or to the load carrier of a lower-pan balance.

The fixation opening can be provided with an internal thread into which a corresponding external thread of the coupling pin can be screwed. However, it is considered more favorable if the input piece has a threaded channel running transversely to the fixation opening to accommodate a clamping screw that clamps the coupling pin in the fixation opening. Hereby, axial or height adjustment can be realized. The coupling pin should be able to be inserted into the fixation opening as positively and axially movably as possible-such as a cylindrical coupling pin in a round fixation bore. The desired relative positioning of the coupling pin and input piece in the axial and azimuthal directions can then be stabilized by the clamping screw in the threaded channel running transverse to the fixation hole. Preferably, the threaded channel runs parallel to the longitudinal extension of the beam of the input piece. Particularly preferably, it extends over the entire length of the beam of the input piece so that the coupling pin inserted into the fixation opening can be fixed from two sides with clamping screws.

On the other hand, it is preferable for the output piece to have a coupling bolt extending coaxially to the central axis on its side facing away from the associated flexure joint. The coupling bolt can, for example, protrude from the end face of the output piece as a single piece of the same material with it. It can be used as an interface for coupling the output piece with the load receptor or (preferably) the load carrier of a lower-pan precision balance. The coupling bolt preferably has a cylindrical basic shape with a lateral clamping plane. If the corresponding interface of the load receptor or load carrier is a sleeve with a lateral threaded channel, the clamping plane of the coupling bolt can serve as an abutment for a clamping screw guided in the threaded channel.

In the disclosed exemplary embodiment of the invention, it is provided that, in order to form a common fixation channel, the fixation opening of the input piece merges into a fixation opening of the output piece which passes completely through the output piece and preferably also through the coupling bolt at least over the length of a partial area thereof. In other words, in the disclosed embodiment, a channel is provided that passes coaxially through the largely entire flexure joint arrangement. Only the tip of the coupling bolt is closed in this embodiment. The skilled person will understand that a fixation pin, which is positively inserted into the flexure joint arrangement according to the invention along the length of such a common fixation channel, blocks both flexure joints simultaneously. Any relative deflection of the input and output piece to the central piece is hereby prevented. Such joint blocking can be particularly useful in transport situations where there is a risk that external forces could exert excessive deflection movements on the filigree flexure joints. When the flexure joint arrangement according to the invention is operated as intended, such a fixation pin must of course be removed at least to such an extent that it no longer crosses the radial plane of the two flexure joints. Only then can the flexure joint arrangement according to the invention perform the two intended pivot movements. In the exemplary embodiment, as explained below, the coupling pin can fulfill the additional function of a temporary fixation pin.

A flexure joint arrangement according to the invention with a common fixation channel can be used to construct a balance according to the invention. In particular, this is a lower-pan balance comprising
a load receptor coupled to a weighing sensor via a weighing system,
a load carrier arranged below the load receptor and
a monolithic flexure joint arrangement of the type disclosed above, with which the load carrier is articulated to the load receptor,
   wherein
either the load receptor has a coupling pin which is fixed in the fixation opening of the input piece of the monolithic flexure joint arrangement, and the load carrier has a fixation sleeve in which the coupling bolt of the output piece of the monolithic flexure joint arrangement is fixed,
or the load carrier has a coupling pin which is fixed in the fixation opening of the input piece of the monolithic flexure joint arrangement, and the load receptor has a fixation sleeve in which the coupling bolt of the output piece of the monolithic flexure joint arrangement is fixed, and wherein the coupling pin is mounted so as to be axially displaceable in the common fixation channel.

With such a balance, it is possible to insert the coupling pin in the operating state only so deeply into the common fixation channel that it does not cross the radial plane of the flexure joints and therefore acts exclusively as a coupling to the load receptor or load carrier. This functional position is referred to here as the operating position. In a further functional position, referred to here as the transport position, it is pushed deeper into the common fixation channel so that it crosses this radial plane, acts as a fixation pin and blocks the flexure joints as described above.

In order to precisely define the two functional positions of the coupling pin, it is preferable for the coupling pin to have two axially spaced annular grooves. These annular grooves serve as contact surfaces for the clamping screw(s) described above in the threaded channel aligned transversely to the fixation opening or the common fixation channel. A precise operating position and an equally precise transport position of the coupling pin are defined hereby. The above-mentioned axial adjustability is lost. However, the azimuthal adjustability also mentioned above is retained. However, the loss of axial adjustability can be easily absorbed at this point in particular if, as provided in the exemplary embodiment, the coupling bolt is provided on the other side of the flexure joint arrangement with a lateral clamping flat extending over a not inconsiderable part of its length. The fixation sleeve of the load carrier or load receptor can be fixed to this clamping plane in different axial positions with a clamping screw (while maintaining its azimuthal alignment). Overall, this embodiment therefore allows both axial adjustability and azimuthal alignment of the load carrier relative to the load receptor.

Further details and advantages of the invention can be seen from the following description and the drawings of an exemplary embodiment.

### BRIEF DESCRIPTION OF THE DRAWINGS

FIG. 1: a perspective view of an exemplary embodiment of a flexure joint arrangement according to the invention,

FIG. 2: a first side view of the flexure joint arrangement of FIG. 1,

FIG. 3: a second side view, offset by 90°, of the flexure joint arrangement of FIG. 1.

FIGS. 4A-4D: side and sectional views of the flexure joint arrangement of FIG. 1 with inserted coupling pin in operating position and

FIGS. 5A-5D: side and sectional views of the flexure joint arrangement of FIG. 1 with inserted coupling pin in transport position.

### DETAILED DESCRIPTION

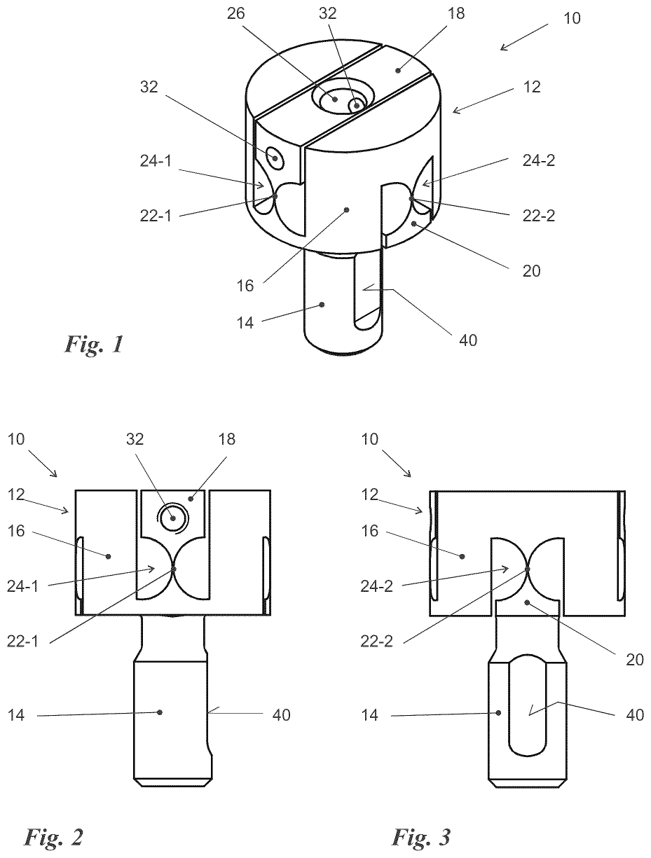

FIGS. 1 to 5D show an exemplary embodiment of a flexure joint arrangement 10 according to the invention. This has a main body 12 of essentially cylindrical basic shape. The main body 12 is adjoined in the figures below by a coupling bolt 14, which will be discussed in more detail below. However, the salient features of the present invention are realized in the main body 12, which will therefore be described alone for the time being.

The main body 12 of the flexure joint arrangement 10 according to the invention comprises a central piece 16. The basic shape of the central piece 16 can be described as a cylinder, in each of the two end faces of which a groove is cut radially through the central piece 16, the two grooves extending perpendicular to one another. The depth of the grooves is selected so that they pass through each other in their intersection area.

A beam-like input piece 18 is arranged in the groove of the central piece 16 shown above in the figures. An output piece 20, which is also beam-like, is arranged in the groove of the central piece 16 shown below in the figures. The input piece 18 and output piece 20 are each articulated to the central piece 16 via a flexure joint 22 formed as a longitudinally extended material thinning region. To differentiate between them, the flexure joint 22 articulating the input piece 18 to the central piece 16 is referred to here as the first flexure joint 22-1 and the flexure joint 22 articulating the output piece 20 to the central piece 16 is referred to as the second flexure joint 22-2.

To form these flexure joints 22, the main body 12 is provided with two vertically intersecting pairs of channels 24, each consisting of two individual through channels with a D-shaped profile. The curved side walls of the individual through channels of each pair of channels 24 face each other and form the webs forming the flexure joints 22 between their apexes. For ease of identification, the pair of channels associated with the first flexure joint 22-1 is referred to here as the first pair of channels 24-1 and the pair of channels associated with the second flexure joint 22-2 is referred to as the second pair of channels 24-2.

The skilled person will recognize that the above description, according to which grooves are “cut” into the main body and the input and output pieces are “arranged” therein, is merely illustrative in nature and does not constitute a description of the actual manufacturing process. In fact, the flexure joint arrangement according to the invention is preferably machined from a block of material, preferably metal, particularly preferably aluminum, e.g. by milling, drilling and/or electrical discharge machining.

The basic function of the flexure joint arrangement 10 according to the invention is realized by the described structure, which can be seen in particular from the synopsis of FIGS. 1 to 3. The input piece 18 and the output piece 20 are pivotable relative to the central piece 16, the precisely defined pivot axes being perpendicular to each other and in the same radial plane in relation to the basic cylindrical shape of the main body 12.

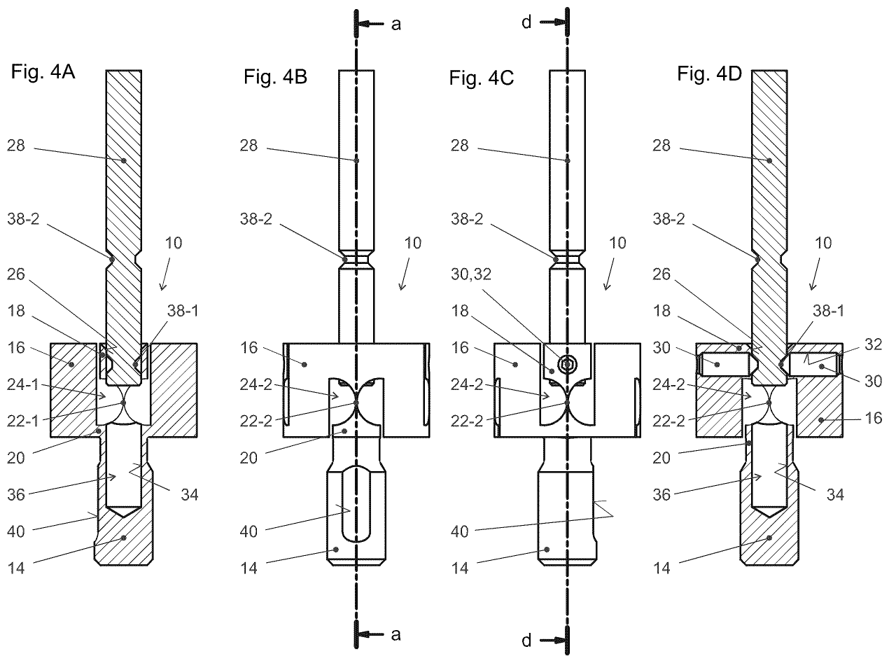

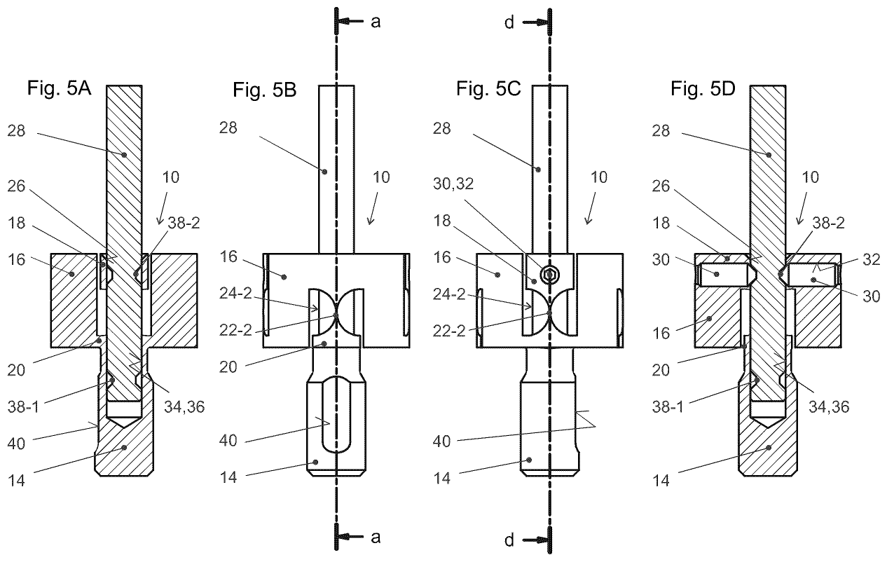

The flexure joint arrangement 10 according to the invention is particularly suitable for coupling a load carrier, not shown in the figures, to the load receptor, also not shown, of a lower-pan precision balance. To facilitate the coupling, the illustrated embodiment provides that the beam of the input piece 18 is provided at a central point with a fixation opening 26, which runs coaxially to the central axis of the main body 12. As shown in FIGS. 4A-4D and 5A-5D, a coupling pin 28 connected or connectable to the load receptor of the balance is positively inserted into this fixation opening 26 and clampingly fixed by clamping screws 30 arranged in a lateral threaded channel 32 of the input piece 18.

In the embodiment shown, the coupling bolt 14, which is preferably to the output piece 20 as a single piece of the same material with it and also extends coaxially to the central axis of the main body, is used to couple the load carrier. In this embodiment, a coupling sleeve (not shown) of the load carrier is pushed positively over the coupling bolt 14 and fixed to the coupling bolt 14 with a clamping screw guided in a lateral threaded channel of the clamping sleeve.

FIGS. 4A-4D and 5A-5D show an exemplary embodiment of the flexible joint arrangement 10 according to the invention in connection with a special configuration of the coupling pin 28. As can be seen in particular in the sectional views of FIGS. 4A and 4D as well as 5A and 5D, not only the input piece 18 is provided with a fixation opening 26 passing completely through it; rather, the output piece 20 and the coupling bolt 14 also have a fixation opening 34, which passes completely through the output piece 20 and only partially through the coupling bolt 14 in the embodiment shown. In any case, this results in a common fixation channel 36, into which the coupling pin 28 is inserted in a form-fitting, axially displaceable manner.

In the embodiment shown, the coupling pin 28 is provided with a first annular groove 38-1 arranged in the vicinity of its free end and with a second annular groove 38-2 spaced further away from the free end. In a first functional position shown in FIGS. 4A-4D, referred to as the operating position, the first annular groove 38-1 is used such that the coupling pin 28 is only immersed in the common fixation channel 36 to such a depth that clamping screws 30 in the lateral threaded channel 32 of the input piece 18 engage in the first annular groove 38-1 and thus (exclusively) fix the coupling pin to the input piece 18. In this operating position, both flexure joints 22 are active, i.e. the input piece 18 can pivot about a first pivot axis relative to the central piece 16 thanks to the first flexure joint 22-1 and the output piece 20 can pivot about a second pivot axis perpendicular thereto relative to the central piece 18 thanks to the second flexure joint 22-2. The input piece 18 is coupled to a load receptor, not shown, of an lower-pan precision balance via the coupling pin 28.

Due to the radial symmetry of the first annular groove 38-1, an azimuthal adjustment of the flexure joint arrangement 10 relative to the coupling pin 28 and thus to the load receptor can be made without changing the height setting. Height adjustment is also readily possible in the embodiment shown. As explained above, the load carrier of the lower-pan precision balance is preferably coupled with a fixation sleeve that positively engages around the coupling bolt 14. In the embodiment shown, however, the coupling bolt 14 has a lateral clamping plane 40. This extends over a not inconsiderable length range of the coupling bolt 14. A fixation sleeve of the load carrier, which positively engages around the cylindrical basic shape of the coupling bolt 14, can be displaced in its height position relative to the coupling bolt 14 and fixed at the desired height via a clamping screw engaging through it laterally on the coupling bolt 14. The lateral clamping plane 40 serves as an abutment for the clamping screw and at the same time ensures reproducible azimuthal alignment of the fixation sleeve relative to the coupling bolt 14.

In the second functional position shown in FIGS. 5A-5D, referred to as the transport position, the coupling pin 28 is pushed further into the common fixation channel 36, namely in particular so far that its second annular groove 38-2 is at the level of the lateral threaded channel 32 of the input piece 18 and its free end projects at least into the fixation opening 34 of the output piece 20, preferably, as shown, into the coupling bolt 14. In this position, the coupling pin 28 can be fixed by the clamping screws 30 and acts as a fixation pin, i.e. it blocks both flexure joints 22 by its positive engagement in all sections of the common fixation channel 36. The input piece 18 and the output piece 20 are thus fixed relative to the central piece 16 in this transport position. Even considerable external forces therefore do not lead to a deflection that overloads and possibly damages the flexure joints 22.

The embodiments discussed in the specific description and shown in the figures are only illustrative examples of the present invention. In the light of the present disclosure, the skilled person is provided with a wide range of possible variations. In its representative embodiment, the entire flexure joint assembly 10 is milled, drilled and/or electro-anodized from a uniform block of metal. However, alternative manufacturing methods, for example using additive manufacturing techniques (e.g. 3D printing) are also feasible.

### LIST OF REFERENCE SYMBOLS

10 flexure joint arrangement
12 main body
14 coupling bolt
16 central piece
18 input piece
20 output piece
22-1 first flexure joint
22-2 second flexure joint
24-1 first pair of channels
24-2 second pair of channels
26 fixation opening in 18
28 coupling pin
30 clamping screw
32 threaded channel
34 fixation opening in 14/20
36 common fixation channel
38-1 first ring groove
38-2 second ring groove
40 lateral clamping plane on 14

What is claimed is:

1. A monolithic flexure joint arrangement comprising a main body through which two pairs of channels, namely a first pair of channels and a second pair of channels, pass and which pairs of channels are aligned perpendicular to each other in a radial plane and intersect each other and a central axis normal to the radial plane in a center of the main body,
wherein each of the pairs of channels has two individual through channels aligned parallel to one another, which are arranged with convexly curved channel wall portions facing one another and adjoining one another such that webs extending between the curved channel wall portions commonly form a flexure joint,
wherein a central piece of the main body is pivotably articulated to an input piece, which is otherwise unconnected thereto, by a first flexure joint formed between the through-channels of the first pair of channels and is pivotably articulated to an output piece, which is otherwise unconnected thereto, by a second flexure joint formed between the through-channels of the second pair of channels, and
wherein the input piece and/or the output piece is configured as a beam passing radially through the central piece.

2. The monolithic flexure joint arrangement according to claim 1,
wherein both the input piece and the output piece are respectively configured as a beam passing radially through the central piece, and wherein the beams are offset against and perpendicular to one another and perpendicular to the central axis.

3. The monolithic flexure joint arrangement according to claim 1,
wherein the input piece has, on a side of the input piece facing away from the first flexure joint, a fixation opening coaxial with the central axis and configured to receive a coupling pin.

4. The monolithic flexure joint assembly according to claim 3,
wherein the input piece has a threaded channel extending transversely to the fixation opening and configured to receive a clamping screw or clamping the coupling pin in the fixation opening.

5. The monolithic flexure joint assembly according to claim 1,
wherein the output piece has, on a side of the output piece facing away from the second flexure joint, a coupling bolt extending coaxially to the central axis.

6. The monolithic flexure joint arrangement according to claim 5,
wherein the coupling bolt has a cylindrical basic shape with a lateral clamping plane.

7. The monolithic flexure joint arrangement according to claim 1, wherein the input piece has, on a side of the input piece facing away from the first flexure joint, a fixation opening coaxial with the central axis and configured to receive a coupling pin,
wherein the output piece has, on a side of the output piece facing away from the second flexure joint, a coupling bolt extending coaxially to the central axis, and
wherein, in order to form a common fixation channel, the fixation opening of the input piece merges into a fixation opening of the output piece which passes through the output piece completely and through the coupling bolt at least over the length of a partial region of the output piece.

8. A lower-pan balance, comprising
a load receptor coupled to a weighing sensor via a weighing system,
a load carrier arranged below the load receptor and
a monolithic flexure joint arrangement according to claim 7, with which the load carrier is articulated to the load receptor,
wherein
either the load receptor has a coupling pin which is configured to be fixed in the fixation opening of the input piece of the monolithic flexure joint arrangement, and the load carrier has a fixation sleeve in which the coupling bolt of the output piece of the monolithic flexure joint arrangement is configured to be fixed,
or the load carrier has a coupling pin which is configured to be fixed in the fixation opening of the input piece of the monolithic flexure joint arrangement, and the load receptor has a fixation sleeve in which the coupling bolt of the output piece of the monolithic flexure joint arrangement is configured to be fixed,
and wherein the coupling pin is mounted to axially displace in the common fixation channel.

9. The balance according to claim 8,
wherein the coupling pin has two axially spaced annular grooves.
